(19) United States
(12) Patent Application Publication
(10) Pub. No.: US 2006/0103348 A1
(43) Pub. Date: May 18, 2006

(54) Maximum and minimum power limit calculator for parallel battery subpacks

(76) Inventor: Robert J. Melichar, Troy, MI (US)

Correspondence Address: HARNESS, DICKEY & PIERCE, P.L.C., P.O. BOX 828, BLOOMFIELD HILLS, MI, 48303, US

(21) Appl. No.: 10/989,159

(22) Filed: Nov. 15, 2004

(51) Int. Cl. H02J 7/00

(52) U.S. Cl. 320/116

(57) ABSTRACT

A battery system according to some implementations of the present invention comprises M battery subpacks that are connected in parallel and that include battery control modules that calculate power values for the battery subpacks. A control module receives the power values from the M battery subpacks and calculates a power value for the battery system based on a power level of one of the battery subpacks times a first factor. The first factor is equal to a sum of one plus ratios of power values of others of the M battery subpacks divided by the power value of the one of the battery subpacks.

### CROSS-REFERENCE TO RELATED APPLICATIONS

This application is related to U.S. patent application Ser. No. ______, filed _ (Attorney Docket No. 2671-000004), which is hereby incorporated by reference.

### FIELD OF THE INVENTION

The present invention relates to batteries and battery systems, and more particularly to a maximum and minimum power limit calculator for batteries and battery systems.

### BACKGROUND OF THE INVENTION

Battery systems may be used to provide power in a wide variety applications. Exemplary transportation applications include hybrid electric vehicles (HEV), electric vehicles (EV), Heavy Duty Vehicles (HDV) and Vehicles with 42-volt electrical systems. Exemplary stationary applications include backup power for telecommunications systems, uninterruptible power supplies (UPS), and distributed power generation applications. Examples of the types of batteries that are used include nickel metal hydride (NiMH) batteries, lead-acid batteries and other types of batteries. A battery system may include a plurality of battery subpacks that are connected in series and/or in parallel. The battery subpacks may include a plurality of batteries that are connected in parallel and/or in series.

The maximum and/or minimum power that can be delivered by batteries, battery subpacks and/or battery systems varies over time as a function of a temperature of the batteries, battery state of charge (SOC) and/or battery age. For example in transportation applications such as HEVs or EVs, it is important for the powertrain control system to know the maximum and/or minimum power limit of the battery system. The powertrain control system typically receives an input request for power from an accelerator pedal. The powertrain control system interprets the request for power relative to the maximum power limit of the battery system (when the battery system is powering the wheels). The minimum power limits may be relevant during recharging and/or regenerative braking. Exceeding the maximum and/or minimum power limits may damage the batteries and/or the battery system and/or reduce the operational life of the batteries and/or the battery system.

In addition, the demands of an application should not be suddenly clamped as the battery system reaches its maximum and/or minimum power limit. To provide smooth operation, the battery system should be able to predict the maximum and/or minimum power limits and communicate the power limits to the application.

A battery control system for a battery pack that contains strings or subpacks of batteries connected in parallel should report a single maximum power available to the particular application controller. The reported maximum power should be within the power capability of each of the strings or subpacks that are connected in parallel. In some conventional approaches, the reported maximum available power is equal to the power of the weakest subpack times the number of strings that are connected in parallel. This reported power level under reports the amount of power available. This is due to the fact that some of the stronger subpacks will operate at a higher potential during discharge and a lower potential in charge. Therefore, the stronger subpacks make up some of the power that is not provided by the weaker subpacks.

### SUMMARY OF THE INVENTION

A battery system according to some implementations of the present invention comprises M battery subpacks that are connected in parallel and that include battery control modules that calculate power values for the battery subpacks. A control module receives the power values from the M battery subpacks and calculates a power value for the battery system based on a power level of one of the battery subpacks times a first factor. The first factor is equal to a sum of one plus ratios of power values of others of the M battery subpacks divided by the power value of the one of the battery subpacks.

In some implementations, the power values from the battery subpacks are maximum power values and/or minimum power values. The battery control modules include a voltage module that measures a voltage across at least one battery during first and second periods. A current sensor measures current supplied by the at least one battery during the first and second periods. A limit module estimates a sum of a polarization voltage and an open circuit voltage of the at least one battery at the second period based on the voltage and current of the at least one battery at the first period and an ohmic resistance of the at least one battery.

In other implementations, the limit module calculates at least one of a maximum current limit and/or a minimum current limit for the at least one battery at the second period based on the sum, at least one of a maximum voltage limit and/or a minimum voltage limit, respectively, and the ohmic resistance of the at least one battery.

In other implementations, the first period occurs before the second period. The limit module calculates at least one of a maximum power limit and a minimum power limit of the at least one battery based on the at least one of the maximum current limit and/or the minimum current limit, respectively, and the at least one of the maximum voltage limit and/or the minimum voltage limit, respectively. The battery subpacks include N batteries that are connected in series with the at least one battery.

In other implementations, the battery control module includes a voltage module that measures voltage across at least one battery at first and second periods. A current sensor measures current supplied by the at least one battery at the first and second periods. A limit module estimates a sum of a polarization voltage and an open circuit voltage of the at least one battery at the second period based on the voltage and current of the at least one battery at the first period and an ohmic resistance of the at least one battery. The limit module calculates at least one of a maximum voltage limit and/or a minimum voltage limit for the at least one battery at the second period based on the sum, at least one of a maximum current limit and/or a minimum current limit, respectively, and an ohmic resistance of the at least one battery. The first period occurs before the second period.

In still other implementations, the limit module calculates at least one of a maximum power limit and a minimum power limit of the at least one battery based on the at least one of the maximum current limit and/or the minimum current limit, respectively, and the at least one of the maximum voltage limit and/or the minimum voltage limit, respectively. The battery subpack includes N-1 batteries connected in series with the at least one battery.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a functional block diagram of an exemplary battery system including battery subpacks with batteries, battery control modules and a master control module;

FIG. 2 is a functional block diagram of an exemplary battery control module;

FIG. 3 is an electrical schematic of an equivalent circuit for an exemplary battery;

FIG. 4 is an exemplary flowchart illustrating steps for generating a maximum power limit for the battery system of FIG. 1 when Vₘₐₓ is known;

FIG. 5 is an exemplary flowchart illustrating steps for generating a minimum power limit for the battery system of FIG. 1 when Vₘᵢₙ is known;

FIG. 6 is an exemplary flowchart illustrating steps for generating a maximum power limit for the battery system of FIG. 1 when Iₘₐₓ is known;

FIG. 7 is an exemplary flowchart illustrating steps for generating a minimum power limit for the battery system of FIG. 1 when Iₘᵢₙ is known; and

FIG. 8 is an exemplary flowchart illustrating steps for calculating a maximum or minimum power limit for a battery system.

### DETAILED DESCRIPTION OF THE PREFERRED EMBODIMENTS

The following description of the preferred embodiment(s) is merely exemplary in nature and is in no way intended to limit the invention, its application, or uses. For purposes of clarity, the same reference numbers will be used in the drawings to identify the same elements. As used herein, the term module refers to an application specific integrated circuit (ASIC), an electronic circuit, a processor (shared, dedicated, or group) and memory that execute one or more software or firmware programs, a combinational logic circuit, and/or other suitable components that provide the described functionality.

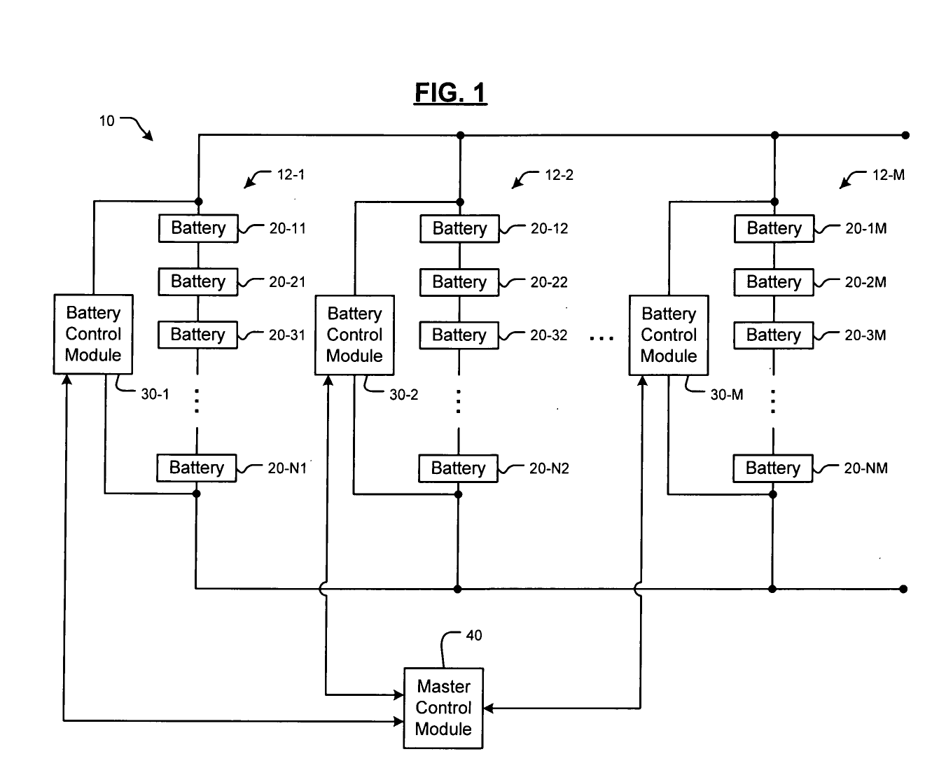

Referring now to FIG. 1, an exemplary embodiment of a battery system 10 is shown to include M battery subpacks 12-1, 12-2, . . . , and 12-M (collectively battery subpacks 12). The battery subpacks 12-1, 12-2, . . . , and 12-M include N series connected batteries 20-11, 20-12, . . . , and 20-NM (collectively batteries 20). Battery control modules 30-1, 30-2, . . . and 30-M (collectively battery control modules 30) are associated with each of the battery subpacks 12-1, 12-2, . . . and 12-M, respectively. In some embodiments, M is equal to 2 or 3, although additional or fewer subpacks may be used. In some embodiments, N is equal to 12-24, although additional and/or fewer batteries may be used.

The battery control modules 30 sense voltage across and current provided by the battery subpacks 12. Alternatively, the battery control modules 30 may monitor one or more individual batteries 20 in the battery subpacks 12 and appropriate scaling and/or adjustment is performed. The battery control modules 30 communicate with a master control module 40 using wireless and/or wired connections. The master control module 40 receives the power limits from the battery control modules 30 and generates a collective power limit. The battery control module 30 may be integrated with the master control module 40 in some embodiments.

Referring now to FIG. 2, some of the elements of the battery control modules 30 are shown. The battery control modules 30 include a voltage and/or current measuring module 60 that measures voltage across the battery subpack 12 and/or across one or more individual batteries 20 in the battery subpack 12. The battery control modules 30 further include a battery state of charge (SOC) module 68 that periodically calculates the SOC of the batteries 20 in the battery subpacks 12. A power limit module 72 calculates a maximum current limit Iₗᵢₘ, voltage limit Vₗᵢₘ, and/or power limit Pₗᵢₘ for the battery subpack 12 and/or one or more batteries 20 in the battery subpack 12, as will be described further below. The limits may be maximum and/or minimum limits. A contactor control module 74 controls one or more contactors (not shown) that are associated with the control and/or connection of the batteries 20 in the battery subpacks 12. A clock circuit 76 generates one or more clock signals for one or more modules within the battery control module 30.

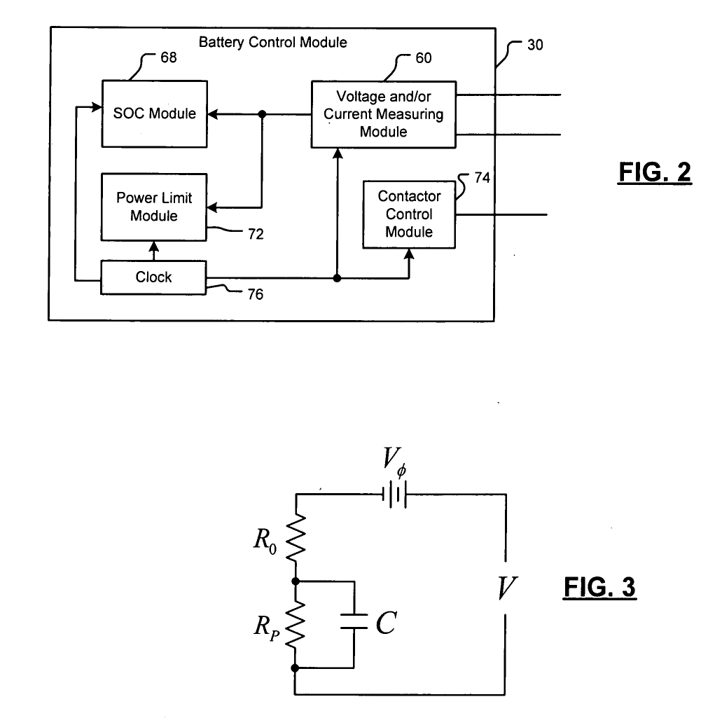

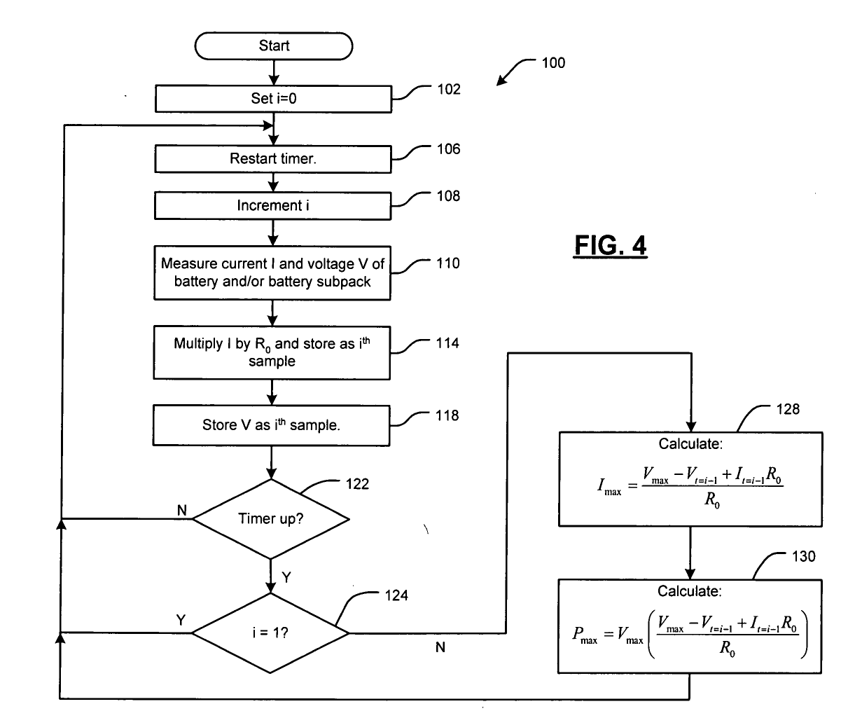

Referring now to FIG. 3, an equivalent circuit for the battery 20 is show where R₀ represents ohmic resistance of the battery, V_{P} represents the polarization voltage, V₀ represents the open circuit voltage, I represents battery current and V represents battery voltage. V and I are measured values. Rₚ varies with temperature, duration of applied current and SOC. V₀ and R₀ vary primarily with SOC. V_{P} is equal to measured current I times Rₚ.

Using the equivalent circuit and Kirchoffs voltage rules for the battery 20, V=V₀+V_{P}+IR₀. By manipulating this equation, an equation for the open circuit voltage V₀ and polarization voltage V_{P} is V_{P}+V_{P}=V−IR₀. The values of V and I are measured by the system and R₀ is estimated. Alternately, the system may perform a continuous calculation of R₀. In particular,

$${R}_{0} = \frac{( {V}_{i} - {V}_{i - 1} )}{( {I}_{i} - {I}_{i - 1} )}$$

when performed on reversal of current.

In one embodiment, the maximum voltage Vₘₐₓ of the system is known and Vₘₐₓ=V₀+V_{P}+IₘₐₓR₀. Substitution of the calculation for V₀+V_{P} from a prior sampling interval into the equation for Vₘₐₓ yields Vₘₐₓ=(V−IRₒ)+IₘₐₓRₒ. In this case, we are assuming that V₀+V_{P} for the current sampling interval is approximately equal to V₀+V_{P} of the prior sampling interval (in other words, V₀+V_{P}≅Vₜ₌ᵢ₋₁−Iₜ₌ᵢ₋₁R₀). This approximation is valid if the sampling interval is sufficiently small since the battery and ambient conditions are very similar. For example in some implementations, a sampling interval 10 ms<T<500 ms may be used, although other sampling intervals may be used. In one embodiment, T=100 ms. If the sampling interval is determined to be excessive in duration then Rₒ would be increased as a constant or as a temperature dependent variable.

Solving for Iₘₐₓ yields the following:

$${I}_{max} = \frac{{V}_{max} - {V}_{t = i - 1} + {I}_{t = i - 1} {R}_{0}}{{R}_{0}} . \\ Therefore , since {P}_{max} = {V}_{max} {I}_{max} , \\ {P}_{max} = {V}_{max} ( \frac{{V}_{max} - {V}_{t = i - 1} + {I}_{t = i - 1} {R}_{0}}{{R}_{0}} ) .$$

Referring now to FIG. 4, a method 100 for calculating Pₘₐₓ is shown. In step 102, i is set equal to 0. In step 106, a timer is reset. In step 108, i is incremented. In step 110, current I and voltage V of one or more batteries 20 and/or the battery subpack 12 are measured. In step 114, I is multiplied by R₀ and stored as the i^{th} sample. In step 118, V is stored as the i^{th} sample. In step 122, control determines whether the timer is up. If step 122 is false, control returns to step 106. If step 122 is true, control continues with step 124 and determines whether i=1. If step 124 is true, control returns to step 106. If step 124 is false, control continues with step 128 and calculates Iₘₐₓ. Control continues with step 130 and calculates Pₘₐₓ, and then returns to step 106.

Additional processing may be performed depending upon the configuration. For example, if V and I are sensed for each battery and there are N batteries are in series, then the Pₘₐₓ and other calculations can be scaled. Other calculations will occur if the N batteries are connected in another fashion. The Pₘₐₓ calculation and other calculations can also be made at other intervals, on demand, when an event occurs, randomly, and/or using any other criteria.

Systems that specify Vₘₐₓ also typically specify Vₘᵢₙ, which yields the following relationships using a similar approach:

$${I}_{min} = \frac{{V}_{min} - {V}_{t = i - 1} + {I}_{t = i - 1} {R}_{0}}{{R}_{0}} . \\ Therefore , since {P}_{min} = {V}_{min} {I}_{min} , \\ {P}_{min} = {V}_{min} ( \frac{{V}_{min} - {V}_{t = i - 1} + {I}_{t = i - 1} {R}_{0}}{{R}_{0}} ) .$$

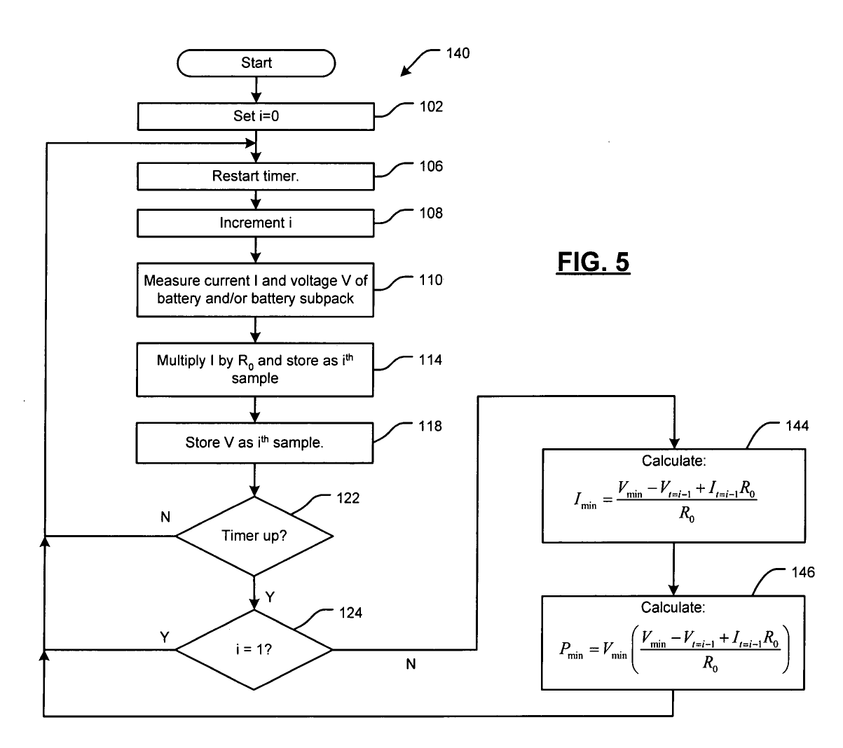

Referring now to FIG. 5, a method 140 for calculating Vₘᵢₙ, is shown. If step 124 is false, control continues with step 144 and calculates Iₘᵢₙ and with step 146 and calculates Pₘᵢₙ. As can be appreciated, steps 144 and 146 can be added to the method 100 in FIG. 4 so that Iₘₐₓ, and Pₘₐₓ, and/or Iₘᵢₙ and Pₘᵢₙ can be calculated.

Alternately for systems having a known Iₗᵢₘ and using a similar approach,
Vₘₐₓ=IₘₐₓR₀+Vₜ₌ᵢ₋₁−Iₜ₌ᵢ₋₁R₀.
Therefore, since Pₘₐₓ=VₘₐₓIₘₐₓ.
Pₘₐₓ=Iₘₐₓ(IₘₐₓR₀+Vₜ₌ᵢ₋₁−Iₜ₌ᵢ₋₁R₀).

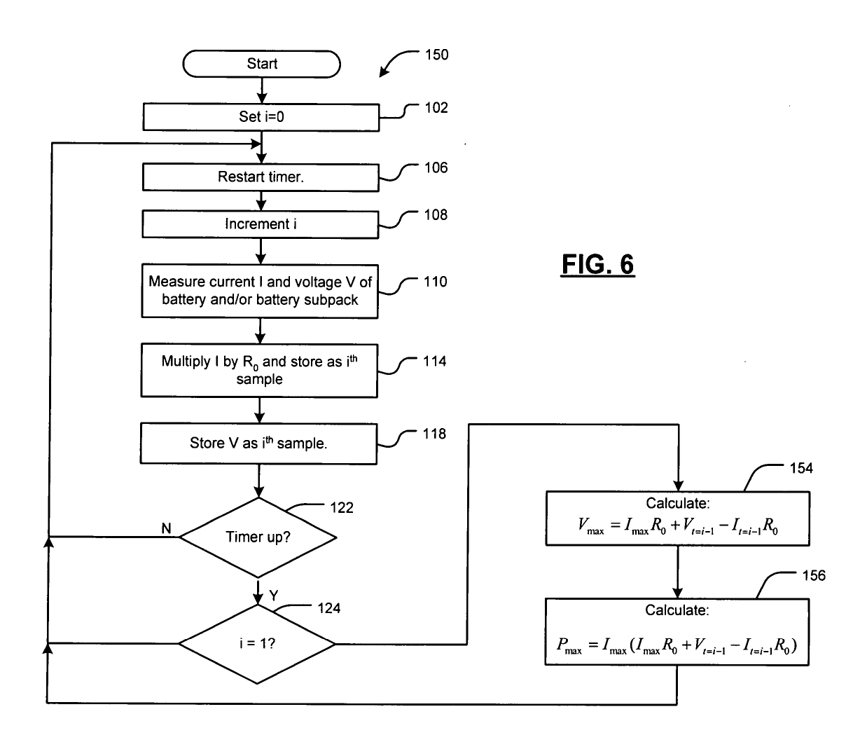

Referring now to FIG. 6, a method 150 for calculating Iₘₐₓ is shown. If step 124 is false, control continues with step 154 and calculates Iₘₐₓ and with step 156 and calculates Pₘₐₓ.

Systems that specify Iₘₐₓ also typically specify Iₘᵢₙ, which yields the following relationships using a similar approach:
Vₘᵢₙ=IₘᵢₙR₀+Vₜ₌ᵢ₋₁−Iₜ₌ᵢ₋₁R₀
Therefore, since Pₘᵢₙ=VₘᵢₙIₘᵢₙ,
Pₘᵢₙ=Iₘᵢₙ(IₘᵢₙR₀+Vₜ₌ᵢ₋₁−I_{y=i-1}R₀).

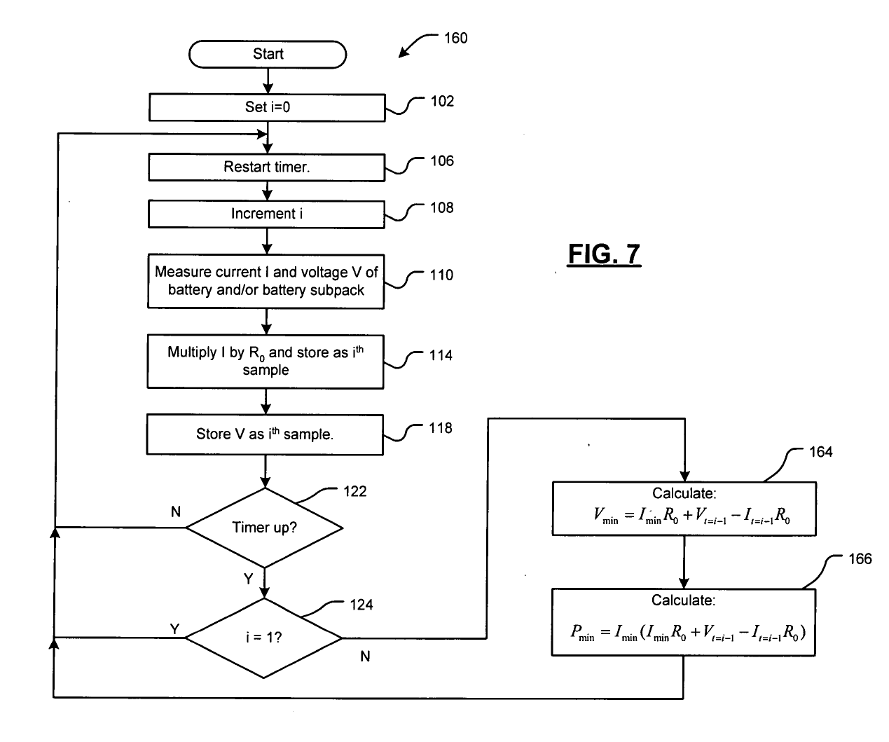

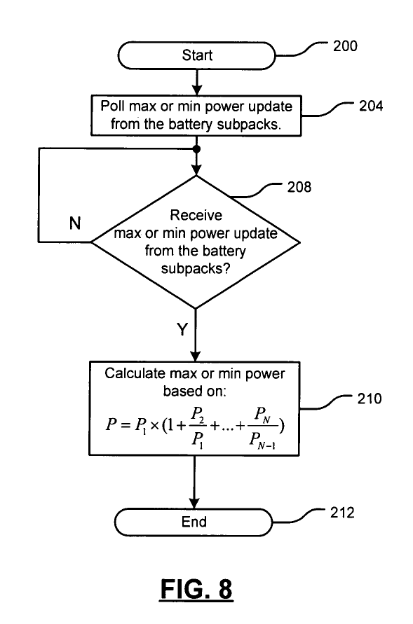

Referring now to FIG. 7, a method 160 for calculating Iₘᵢₙ is shown. If step 124 is false, control continues with step 164 and calculates Iₘᵢₙ and with step 166 and calculates Pₘᵢₙ. As can be appreciated, steps 164 and 166 can be added to the method 150 in FIG. 6 so that Iₘₐₓ and Pₘₐₓ and/or Iₘᵢₙ and Pₘᵢₙ can be calculated.

The master control module 40 receives the maximum power values and/or minimum power values from respective ones of the battery subpacks 12 and calculates the maximum and/or minimum power available based on the following equation:

$$P = {P}_{1} \times ( 1 + \frac{{P}_{2}}{{P}_{1}} + … + \frac{{P}_{N}}{{P}_{1}} )$$

where N is the number of battery subpacks and wherein Pₓ is the maximum or minimum power of the x^{th} battery subpack. As can be appreciated, any one of the battery subpacks can be used instead of P₁.

For the case where there are two battery subpacks, the power reported by each of the battery subpacks is:
P₁=I₁×V₁;
P₂=I₂×V₂; and
P₃=I₃×V₃.

In some embodiments, the power limitations are based on Vₘᵢₙ (given) and in parallel, the voltages V₁ and V₂ are equal. Therefore,

$${V}_{min} = {V}_{2} = \frac{{P}_{2}}{{I}_{2}} = {V}_{1} = \frac{{P}_{1}}{{I}_{1}} .$$

Rearranging the preceding and solving for I₂ in terms of I₁, P₂ and P₁, yields the following equation:

$${I}_{2} = {I}_{1} \times \frac{{P}_{2}}{{P}_{1}} .$$

The power available is the sum of the power of each of the battery subpack and Vₘᵢₙ is substituted for the respective voltages as follows:
P=(V₁×I₁)+(V₂×I₂)=Vₘᵢₙ×(I₁+I₂).
Substituting in for I₂ gives the following relationship:

$$P = {V}_{min} \times ( {I}_{1} + {I}_{1} \times \frac{{P}_{2}}{{P}_{1}} ) .$$

Multiplying and dividing the right side of the preceding equation by I₁ yields the following relationship:

$$P = {P}_{1 \_min} \times ( 1 + \frac{{P}_{2 \_min}}{{P}_{1 \_min}} ) .$$

As can be appreciated, the same substitution approach can be used to extend the formula to N subpacks as shown above. Likewise, the formula can be extended maximum voltage-based calculations using Vₘₐₓ.

$${P}_{max} = {P}_{1 \_max} \times ( 1 + \frac{{P}_{2 \_max}}{{P}_{1 \_max}} ) .$$

Likewise, the formula can be extended maximum and minimum current-based calculations using Iₘₐₓ and Iₘᵢₙ.

Referring now to FIG. 8, steps for calculating maximum or minimum power for battery subpacks is shown. In step 200, control begins. In step 204, the master control module polls the battery subpacks for the maximum and/or minimum power calculations. In step 208, control determines whether all of the battery subpacks have responded. If not, control returns to step 208. When step 208 is true, control calculates the maximum and/or minimum power as described above in step 210. Control ends in step 212. While a polling or pull technique is described, a push technique may be used. In the push technique, the battery subpacks automatically send the maximum or minimum values to the master control module.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, the specification and the following claims.

What is claimed is:

1. A battery system comprising:
M battery subpacks that are connected in parallel and that include battery control modules that calculate power values for said battery subpacks;
a control module that receives said power values from said M battery subpacks and that calculates a power value for said battery system based on a power level of one of said battery subpacks times a first factor, wherein said first factor is equal to a sum of one plus ratios of power values of others of said M battery subpacks divided by said power value of said one of said battery subpacks.

2. The battery system of claim 1 wherein said power values from said battery subpacks are maximum power values.

3. The battery system of claim 1 wherein said power values from said battery subpacks are minimum power values.

4. The battery system of claim 1 wherein said battery control modules include:
a voltage module that measures a voltage V across at least one battery during first and second periods;
a current sensor that measures current I supplied by the at least one battery during said first and second periods; and
a limit module that estimates a sum of a polarization voltage V_{P} and an open circuit voltage V_{φ} of the at least one battery at said second period based on said voltage V and current I of the at least one battery at said first period and an ohmic resistance R₀ of the at least one battery.

5. The system of claim 4 wherein said limit module calculates at least one of a maximum current limit Iₘₐₓ and/or a minimum current limit Iₘᵢₙ for the at least one battery at said second period based on said sum, at least one of a maximum voltage limit Vₘₐₓ and/or a minimum voltage limit Vₘᵢₙ, respectively, and said ohmic resistance R₀ of the at least one battery.

6. The system of claim 4 wherein said first period occurs before said second period.

7. The system of claim 5 wherein said limit module calculates at least one of a maximum power limit and a minimum power limit of the at least one battery based on said at least one of said maximum current limit Iₘₐₓ and/or said minimum current Iₘᵢₙ limit, respectively, and said at least one of said maximum voltage limit Vₘₐₓ and/or said minimum voltage limit Vₘᵢₙ, respectively.

8. The battery system of claim 4 wherein said battery subpacks include N batteries that are connected in series with said at least one battery.

9. The battery system of claim 1 wherein said battery control module includes:
a voltage module that measures voltage V across at least one battery at first and second periods;
a current sensor that measures current I supplied by the at least one battery at said first and second periods; and
a limit module that estimates a sum of a polarization voltage V_{P} and an open circuit voltage V_{φ} of the at least one battery at said second period based on said voltage V and current I of the at least one battery at said first period and an ohmic resistance R₀ of the at least one battery.

10. The system of claim 9 wherein said limit module calculates at least one of a maximum voltage limit Vₘₐₓ and/or a minimum voltage limit Vₘᵢₙ for the at least one battery at said second period based on said sum, at least one of a maximum current limit Iₘₐₓ and/or a minimum current Iₘᵢₙ limit, respectively, and an ohmic resistance R₀ of the at least one battery.

11. The system of claim 9 wherein said first period occurs before said second period.

12. The system of claim 10 wherein said limit module calculates at least one of a maximum power limit and a minimum power limit of the at least one battery based on said at least one of said maximum current limit Iₘₐₓ and/or said minimum current Iₘᵢₙ limit, respectively, and said at least one of said maximum voltage limit Vₘₐₓ and/or said minimum voltage limit Vₘᵢₙ, respectively.

13. The battery system of claim 9 wherein said battery subpack includes N-1 batteries connected in series with said at least one battery.
